(19) United States
(12) Patent Application Publication
(10) Pub. No.: US 2022/0226941 A1
(43) Pub. Date: Jul. 21, 2022

(54) QUICK-CHANGE SYSTEM FOR SHIELDING-GAS DRAG NOZZLES

(71) Applicant: LINDE GMBH, Pullach (DE)

(72) Inventor: Michael PFREUNTNER, Unterschleißheim (DE)

(21) Appl. No.: 17/595,484

(22) PCT Filed: May 19, 2020
(86) PCT No.: PCT/EP2020/025232

§ 371 Date: Nov. 17, 2021

(30) Foreign Application Priority Data
May 28, 2019 (EP) 19020349.7

(51) Int. Cl. B23K 37/00

(52) U.S. Cl. CPC B23K 37/00; B23K 9/325

(57) ABSTRACT

The invention relates to a device for replaceably fastening a gas nozzle, comprising an elongate support element which has a nozzle portion for fastening a gas nozzle and is provided with a curved mounting portion, and a holding component which is provided with at least one recess which is shaped in such a way that the mounting portion of the support element can be inserted into the recess so as to produce a form-fitting engagement between the support element and the holding component.

The invention relates to a device for replaceably fastening a gas nozzle for a welding process.

In the field of welding technology, gases are introduced into the working area at the workpiece for various purposes. In particular, these gases are shielding gases, i.e., for example, inert gases, which form a gas layer around the processing area and prevent oxidation of the materials during or after a welding process or during a heat treatment. In addition, gases can be used in a targeted manner in order to influence processing parameters. The shielding gas is usually dispensed via nozzles integrated with the burner. Depending on the processed material and the desired effect, it may also be necessary or expedient to apply a gas to the further or already processed region in addition to the shielding gas in the direct processing area, for example until the temperature drops below the oxidation temperature. This secondary gas protection is often achieved by so-called drag nozzles, which are additionally attached to the burner or to trailing covers, such as a drag shoe.

The drag nozzle is usually fastened to the burner or to the drag shoe via hose clamps and similar clamping elements. A clamp is thus, for example, fastened to the burner tube, into which a gas nozzle can be inserted, which can then be firmly clamped therein by screwing the clamp. As a further possibility, nozzles are used which are provided with a suitable thread and are firmly screwed to the burner element or a cover. Drag nozzles can likewise already be firmly integrated into a burner.

In all these cases, however, an exchange of the shielding-gas nozzle, for example for cleaning, or an exchange of the burner electrode becomes very complex so that the downtime during welding processes is increased.

The object of the invention is therefore to achieve a simpler arrangement of a gas nozzle.

This object is achieved in that a device for replaceably fastening a gas nozzle is proposed, wherein the device comprises a long support element, which has a nozzle portion for fastening a gas nozzle and is provided with a curved mounting portion, and a holding component provided with at least one recess which is shaped in such a way that the mounting portion of the support element can be inserted into the recess so as to produce a form-fitting engagement between the support element and the holding component. In this way, by simple mounting and demounting, a gas nozzle can be fastened in a corresponding holding component and can be replaced quickly without using tools. Such a device is in particular suitable for drag gas nozzles, which are additionally attached, but can also be used for other gas nozzles.

In this case, the holding component can comprise an adapter ring, which can be fastened to a tubular component, such as directly to a burner or another element.

A recess can then be arranged, for example, in an axial end surface and/or in the outer circumferential surface of the adapter ring. The fastening can thus be flexibly adapted to the respective space conditions.

The adapter ring can also be provided with a plurality of recesses spaced apart from one another in the axial direction and/or along the circumference of the adapter ring, so that a quick change in the nozzle position at defined distances is possible even without repositioning the adapter ring.

Optionally, a recess may extend at an angle to the central axis of the adapter ring, wherein the angle is less than 90°. All recesses can be produced as a blind hole, an elongated hole, or as a through-hole or in the form of a milled hole. Such a recess may, for example, be implemented by milling along the circumferential direction of the adapter ring.

The shape of the at least one recess preferably substantially corresponds to the shape of the mounting portion, wherein the dimensions can be provided to fit relatively precisely or with play as long as the components are held sufficiently firmly to one another.

In one embodiment, the support element can be made of a strip-shaped piece of material, for example of a sufficiently thick strip of sheet metal, which can be shaped into a support element in a simple manner by bending or other forming methods.

In a further embodiment, the holding component can be formed in one piece with a welding burner or a holder for a welding burner so that no adapter is necessary.

A device for fastening gas nozzles according to the invention offers various advantages. Since the gas nozzle can be fixed to the rigid support element and the position and distance from the adapter ring can thus remain constant, the optimal distance of the gas nozzle from the processing area can be reliably maintained. By moving the adapter ring on the burner, this distance can also be changed and set to a new value as desired. Mounting and demounting of the nozzle without a tool is possible and facilitates exchanging or cleaning the nozzle, so that downtimes are considerably reduced. Exchanging the gas nozzle appropriately for the respective welding task is easily possible due to the fast installation. Such a system can moreover be used with any burner as long as the corresponding adapter element can be attached or a suitable recess for the support element be present. For example, adapter rings in different diameters can be provided with a single nozzle support element and can thus be adapted to a plurality of burner types. A further advantage is that even if the gas nozzle collides with the component surface, for example by bumping, the fastening of the gas nozzle thus designed will yield and, for example, be partially pushed upwards out of the recess so that the burner and the gas nozzle are not damaged in the process.

The invention and further details of the invention are explained in more detail below with reference to exemplary embodiments schematically illustrated in the drawings, wherein

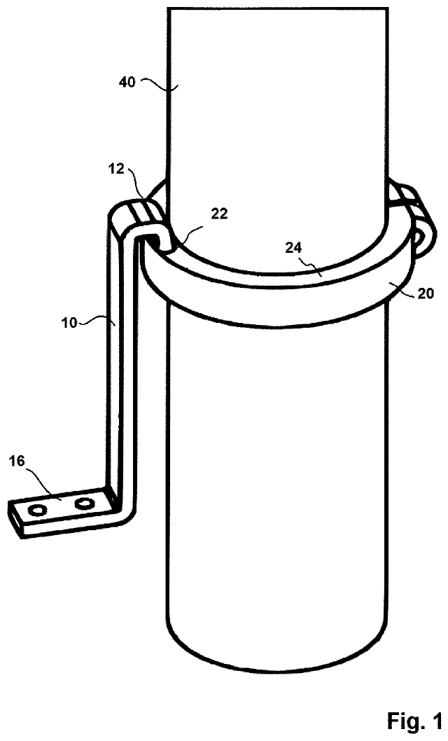

FIG. 1 shows a perspective view of an adapter ring on a burner with a support element according to one embodiment of the invention;

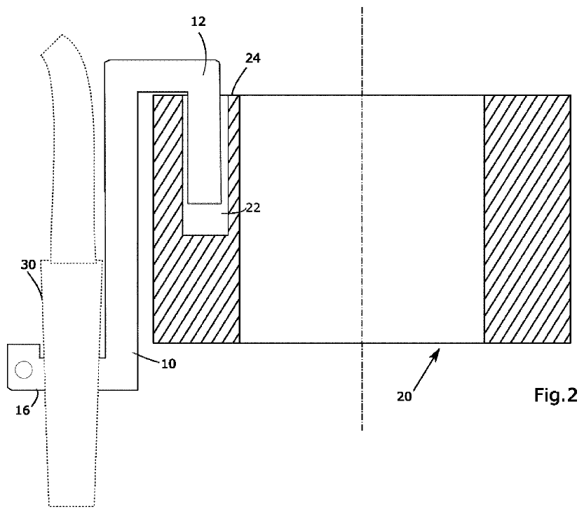

FIG. 2 outlines a cross-section of a first embodiment of the invention with a perpendicular blind hole;

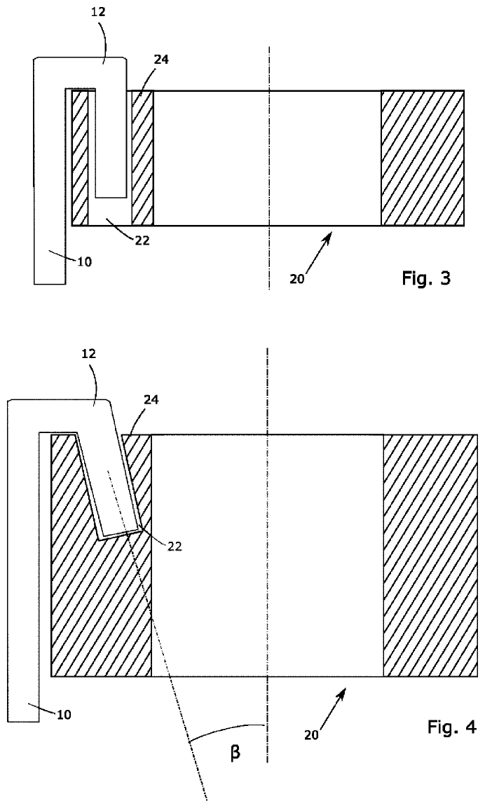

FIG. 3 outlines a cross-section of a further embodiment of the invention with a perpendicular through-hole;

FIG. 4 shows a cross-section of a further embodiment of the invention with a recess inclined in relation to the axis;

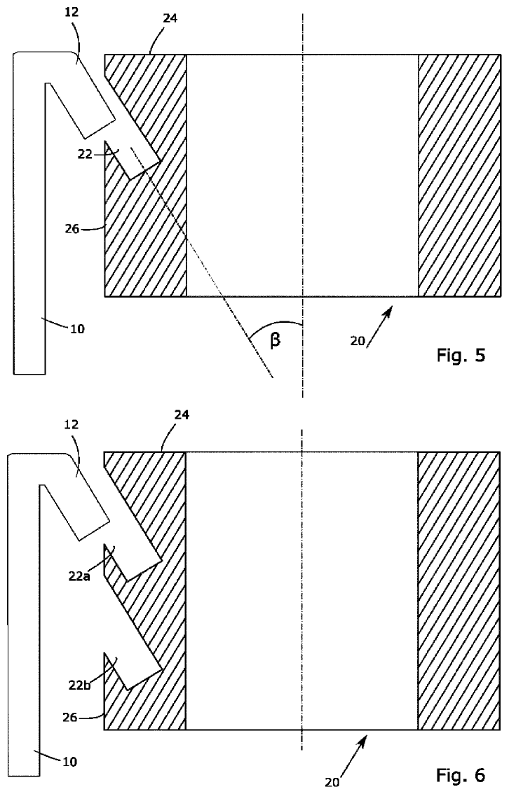

FIG. 5 shows a cross-section of a further embodiment of the invention with a recess in the circumferential surface; and

FIG. 6 shows a cross-section of a further embodiment of the invention with a plurality of recesses in the circumferential surface.

### DETAILED DESCRIPTION

According to one embodiment of the invention, a quick-change holder is provided, which comprises a support element for a gas nozzle and a corresponding recess on a holding component, such as on a burner, on an adapter element, or on another suitable element. The recess is designed in such a way that a curved mounting portion of the support element can be inserted into the recess, where it can hold the support element in a predetermined position by a form fit. The dimensions of the recess thus correspond to at least the mounting portion to be inserted therein but can also be designed to be larger by a certain amount as long as a secure hold of the support element in the recess is ensured. If an adapter element is used, it should be dimensioned with respect to its wall thickness or circumference in such a way that the recess can be accommodated therein. In this case, the recess can be essentially open in a direction which points away from the burner nozzle during operation when the adapter element is attached.

The quick-change holder can preferably be designed as a two-part device in which a separate adapter element with the corresponding recess is provided as the holding component. The adapter element in turn has fastening regions with which it can be fastened, for example, to a welding burner 40 or another tubular component, such as a holder. In an exemplary embodiment shown in a perspective in FIG. 1, the adapter element may be a one-piece or multi-piece adapter ring which is designed in such a way that it can, for example, be fitted around or plugged onto a burner tube and can be clamped and fixed there by screwing.

At at least one location on the adapter ring 20, a recess 22 can then be provided which is shaped in such a way that it can receive a mounting portion 12 of a support element 10 and can bring the support element into form-fitting engagement with the adapter ring 20. In a simple embodiment, the end region of the support element 10 and thus also the recess 22 can be formed with a uniform rectangular or flat cross-section, or alternatively with a cross-section that follows the curved circumference of the adapter ring, for example. In this case, the recess can, for example, be provided in an axial end surface 24 of the adapter ring 20 and extend substantially perpendicularly to the ring axis so that the mounted support element, by means of its weight force, brings about the form fit.

Alternatively, the recess 22 may also extend at an angle β to the axis of the adapter ring 20, as described in more detail in further embodiments, wherein the angle should be less than 90° and preferably may be less than approximately 45° or less than 30° in order to ensure a secure form fit upon mounting. Accordingly, the mounting portion 12 of the support element 10 can then also extend at an angle.

The support element 10 shown in FIG. 1 is designed in the shape of a simple strip-shaped bracket. Such a support element 10 can be produced very simply by suitable forming methods from a strip-shaped piece of material, for example a sufficiently sturdy sheet of metal, and therefore offers a particularly cost-effective production method. However, differently shaped support elements that follow the same fastening principle in a corresponding recess 22 may likewise be used.

FIGS. 2 to 6 show, by way of example, radial cross-sections through an adapter ring 20 in the region of one or more recesses 22, wherein correspondingly shaped support elements 10 can be inserted into the recesses. It goes without saying that the features shown there by way of example can be transferred to recesses in other elements, for example in non-annular support elements, or recesses integrally provided in burner holders or other components. Moreover, the elements may have further components, such as fastening elements, clamping screws, further openings, and others not illustrated in these schematic drawings.

FIG. 2 shows a radial cross-section through an adapter element in the form of an adapter ring 20, which can be attached to a burner 40 or a holder, etc., as in FIG. 1. Here, the recess 22 for the support element is introduced in the form of a perpendicular blind hole into the upper ring surface 24, i.e., into the surface that faces away from the burner nozzle during operation. As can be seen in the figure, the suitably shaped support element with a curved end region 12 is mounted in the recess 22 so that a secure form fit is produced by the weight force of the support element 10 and of the nozzle 30 fastened thereto. At the same time, the connection can be released again by simply lifting the support element 10 in the opposite direction, and the gas nozzle 30 attached to the support element 10 can thus be changed quickly. The mounting portion 12 is shown here as an angularly curved region with two substantially right-angled bends but may also be curved or rounded in shape, for example with a U-shaped profile.

At its other end, the support element 10 comprises a nozzle portion 16 for fastening a gas nozzle 30, in which nozzle portion 16 integrated fastening means or receptacles for separate fastening means can be provided, for example, in order to fasten a gas nozzle to the support element. These means can be openings for screws, clamping elements such as hose clamps, internal or external threads for receiving a correspondingly shaped mating thread, or other means. A gas nozzle 30 can then be rigidly fixed either releasably or permanently to the support element 10 by means of these fastening means. The fastening means can also be designed in such a way that various nozzle elements, for example with different diameters, or different fastening systems, such as screws and clamping holders, can be connected thereto. In the following figures, for the sake of simplicity the nozzle portion 16 of the support element 10 is no longer shown but is naturally to be transferred to these examples. In contrast, the shape and design of the nozzle portion can also be designed differently than is shown here as long as the gas nozzle can be fastened.

FIG. 3 shows an adapter ring 20 in which, as in FIG. 2, a recess 22 extending in parallel to the ring axis is introduced into the end surface 24 of the ring. However, the recess here takes the form of a through-hole. The corresponding mounting portion 12 of the support element can then be designed to be shorter or longer than the hole so that the mounted support element 12 can, depending on the dimension, also exit again at the other ring surface. The extended length of the mounting portion 12 can ensure a particularly stable seat.

FIG. 4 shows an embodiment in which a recess 22 is likewise arranged in the axial end surface 24 but is tilted outwardly with respect to the central axis of the ring 20 by an angle 3. Such a design can simplify the insertion of the support element 12 into the recess and moreover also offers a slight resistance to the support element 10 being pushed out upwardly, for example when the support element or the gas nozzle is accidentally bumped. The angle and dimensions of the mounting portion are preferably matched to one another in order to ensure a secure hold.

FIG. 5 shows an embodiment in which a recess 22 is arranged in the outer circumferential surface 26 of the adapter ring 20. As already in the previous embodiment, the recess is tilted at an angle β to the axis. A recess in the circumferential surface 26 offers advantages, for example, when there is only little space in the upward direction along the ring axis (or the burner axis). In particular, such a recess can also be easily introduced into any other components with sufficient wall thickness, for example directly into a holder or sheath of a welding burner.

Lastly, FIG. 6 shows an adapter ring 20 in which two recesses 22a, 22b designed as in FIG. 5 are introduced one above the other. It goes without saying that the recesses need not be arranged directly one above the other but can also be arranged at an offset over the circumference of the ring 20. In this way, several holding options can be provided for the gas nozzle 30 at various distances from the workpiece, which holding options can also be quickly adjusted without moving the adapter element 20 and thereby enable precisely defined dimensions. Significantly more than two recesses could thus also be introduced along the axis of the burner and the nozzle position could flexibly be varied by mounting or demounting the support element without having to displace the adapter ring 20.

Additionally or alternatively, a plurality of recesses 22 may also be arranged around the circumference of the adapter ring 20 in all embodiments shown. The angle of the gas nozzle 30 to the processing area can thus be adjusted quickly, or the gas nozzle can be moved at short notice in the case of particular space conditions, in particular during manual welding.

In addition, recesses in the circumferential surface 26 and recesses in the end surface 24 can naturally be combined with one another as desired.

In a further embodiment, the recess for receiving the mounting portion may also comprise a plurality of separate regions. For example, the end region of the support element could be designed in such a way that two or more separate hooked arms engage in corresponding suitable recesses in the adapter ring. The recesses for these arms could be designed to be contiguous or separate.

A wider or stepped adapter ring could also be used, which makes it possible to easily change the distance of the gas nozzle from the burner, even in the radial direction. For example, a plurality of recesses spaced apart from one another in the radial direction could be introduced on a wider adapter ring so that a suitably shaped mounting portion with a sufficiently wide support surface can be mounted at various radii or distances from the burner axis.

For all embodiments, the mounting portion should be designed in such a way that it can be mounted in the adapter ring in any position provided without compromising the correct mounting and the firm seating of the gas nozzle. For this purpose, the upper region that adjoins the mounting portion 12 and comes to rest on the edge of the adapter ring in embodiments, as shown, for example, in FIGS. 2 and 3, should have a sufficient width. The distance of the attached gas nozzle from the burner can optionally also be defined via the width of this region.

It is also conceivable to form a gas nozzle 30 in one piece with a corresponding support element, i.e., for example, with a corresponding mounting portion, which is provided for mounting in the recesses as described above.

Suitable as the material for the support element 10 and the holding component 20 is, for example, a metal, such as any steel, but plastics or other suitable materials are also conceivable. It goes without saying that heat resistance and other features, such as the sufficient rigidity of the material, are to be considered in the selection. Optionally, for example, a compressible elastomer coating of the recess 22 and/or of the mounting portion 12 could also contribute to more firmly fastening the support element 10 in the recess 22 by clamping force.

If a drag shoe or a similar cover or burner configuration is used, a corresponding recess can also be provided directly in the cover instead of an adapter element.

Likewise, a burner could also already be equipped in one piece with a holding component that has at least one corresponding recess.

All configurations and options described above for an adapter element can naturally likewise be applied to recesses in other elements.

It goes without saying that all embodiments of the invention and combinations thereof can be used not only in the described situations but in all applications in which a gas nozzle or similar devices are to be fastened. In particular, such a fastening can be used not only for a drag gas nozzle for secondary gas protection but also as a holder for a primary shielding-gas nozzle or active-gas nozzle and can be used for all types of burners or welding devices. It likewise goes without saying that described elements, such as the adapter ring, do not necessarily have to be annular but can be designed as desired in particular toward the outside in the free region.

### LIST OF REFERENCE SIGNS

10 Support element
12 Mounting portion
16 Nozzle portion
20 Adapter ring
22 Recess
24 Axial end surface of the adapter ring
26 Outer circumferential surface of the adapter ring
30 Gas nozzle
40 Burner

1-12. (canceled)

13. A device for replaceably fastening a gas nozzle, comprising:
an elongate support element which has a nozzle portion for fastening the gas nozzle and is provided with a curved mounting portion, and
a holding component which is provided with at least one recess which is shaped in such a way that the mounting portion of the support element can be inserted into the recess so as to produce a form-fitting engagement between the support element and the holding component.

14. The device according to claim 13, wherein the holding component comprises an adapter ring which can be fastened to a tubular component.

15. The device according to claim 14, wherein the at least one recess is arranged in an axial end surface of the adapter ring.

16. The device according to claim 14, wherein the at least one recess is arranged in the outer circumferential surface of the adapter ring.

17. The device according to claim 14, wherein the adapter ring is provided with a plurality of recesses spaced apart from one another in the axial direction and/or along the circumference of the adapter ring.

18. The device according to claim 14, wherein the recess extends at an angle to the central axis of the adapter ring, wherein the angle is less than 90°.

19. The device according to claim 13, wherein the at least one recess is produced as a blind hole or as a through-hole or by means of milling.

20. The device according to claim 13, wherein the shape of the at least one recess substantially corresponds to the shape of the mounting portion.

21. The device according to claim 13, wherein the support element is made of a strip-shaped piece of material.

22. The device according to claim 13, wherein the holding component is formed integrally with a welding burner or a holder for a welding burner.

23. The device according to claim 13, having a gas nozzle fastened to the nozzle portion.

24. A burner having a device according to claim 23, wherein a component of the burner or the burner itself is connected to the device by means of the holding component.
